(19) United States
(12) Patent Application Publication
(10) Pub. No.: US 2007/0176734 A1
(43) Pub. Date: Aug. 2, 2007

(54) Input unit for a field device

(75) Inventor: Eugenio Ferreira Da Silva Neto, Biel-Benken (CH)

Correspondence Address: BACON & THOMAS, PLLC, 625 SLATERS LANE, FOURTH FLOOR, ALEXANDRIA, VA, 22314, US

(73) Assignee: Endress + Hauser Process Solutions AG, Reinach (CH)

(21) Appl. No.: 10/569,790

(22) PCT Filed: Jul. 16, 2004
(86) PCT No.: PCT/EP04/07978

§ 371 Date: Nov. 14, 2006

(30) Foreign Application Priority Data
Aug. 25, 2003 (DE) 103393498

(51) Int. Cl. G05B 19/00

(52) U.S. Cl. 340/5.8; 340/3.5; 713/186; 382/119

(57) ABSTRACT

An input unit for a field device, has a registering unit for an electronic identifier of a user, which enables a definite identification of the user.

The invention concerns an input unit for a field device, according to the preamble of claim 1.

Field devices are used e.g. in process automation technology. They serve to record, register, and/or influence process variables. Examples for such field devices are fill level measuring devices, recording devices, e.g. paperless recorders, mass-flow measuring devices, pressure- and temperature measuring devices, which, as sensors, register the corresponding process variables fill level, flow-rate, pressure, temperature, pH-value, and conductivity, respectively.

In addition to such measuring and recording devices, systems are known in the field of process automation which, in addition to the pure registering of the measured values, also fulfill further tasks. Worth mentioning here are especially electrode-cleaning systems, calibration systems, as well as samplers.

Input/output units, so-called “Remote I/O's”, are likewise designated as field devices.

For influencing process variables, actuators are used, which, e.g. as valves, control the flow-rate of a liquid in a pipe-section, or, as, pumps alter the fill level in a container.

A wide variety of such field devices are produced and sold by the firm Endress+Hauser®).

Field devices in modern fabrication plants are often connected via a field bus system (e.g. Profibus®, Foundation Fieldbus, HART, etc.) to superordinate units e.g. control systems or control units.

These superordinate units are used for process control, process visualization, process monitoring, as well as for servicing the field devices.

Field bus systems are often also connected with different company networks.

For servicing the field devices, appropriate service programs (configuration, service, or operating tools) are necessary in the control system, respectively control unit. These service programs can run independently, or also be integrated in larger control system applications.

The sensors supply the measured values, which correspond to the current values of the registered process variables. These measured values are relayed to a recording device and/or a control unit e.g. a PLC (programmable logic controller) and are there recorded and/or evaluated.

Process control is normally accomplished by control units in which the measured values of the different field devices are evaluated, and, on the basis of the evaluation, control signals for the corresponding actuators are generated.

In addition to the pure transfer of measured values, modern field devices also supply additional information concerning diagnostics, status, etc. The parameterization and configuration of the field device can also be accomplished using the field bus system.

Field bus systems are also generally designated as process control systems.

Safety requirements for the production of certain products (pharmaceuticals, foods, cosmetics) are becoming increasingly stricter. The regulations of the US governmental agency FDA at 21 CFR PART 11 Rules provide an example of this. The corresponding production plants and manufacturing processes must pass strict inspections, and adherence to the regulations must be constantly monitored.

The producers are obligated to provide appropriate evidence which proves that their production processes are carried out in accordance with the specifications and quality control requirements. This procedure is referred to as validation. The properties of a product are influenced by, among other things, the process control system. Counted in this are especially the field devices and the control systems. For comprehensive plant documentation, it is necessary to capture and archive inspection records, inspection reports, and calibration records. These records and reports thus far have been filed in paper form. With the progress of electronic archiving, it is also possible to file these documents in electronic form. The FDA regulations, 21 CFR PART 11, concern in particular the electronic archiving of different data. These regulations furthermore provide that documents can be signed electronically.

An electronic signature, or a signature by hand, as the case may be, is supposed to ensure that it is always traceable who signed which documents, and who made which modifications to field devices, respectively control systems.

Until now, it has been common practice to take calibration records and inspection reports in paper form into the production plants, and to sign them at the field device to be examined. Previously, inputs (e.g. parameter modifications) could be easily carried out at the field device, without the corresponding person needing to be identified after the fact.

An object of the invention is to provide for a field device an input unit enabling a simple and secure identification of the user, and especially enabling a validation of plants, respectively plant components, in accordance with the official regulations.

This object is achieved through the features provided in claim 1.

Advantageous further developments of the invention are provided in the dependent claims.

An essential idea of the invention is that an input unit for a field device is equipped with a registering unit for an electronic identifier of a user, which permits a definite identification of a user, and which is, therefore, in accordance with the new validation demands for plants/plant components.

The electronic identifier can involve e.g. the signature of a user.

In a further development of the invention, the signature is entered using a display (LCD-display) provided on the input unit.

In accordance with a further development, electronic documents shown on the display can be signed by the user in handwriting, and/or annotated in handwriting, using inputs via the display.

Advantageously, annotations to the electronic documents are saved such that they are unchangeable, and/or are provided with the clock time of the input.

In an alternative embodiment of the invention, the signature is transferred from a portable transmitter to the registration unit.

Advantageously, the signature can serve for signing electronic documents which are shown in the display of the input unit.

Advantageously, the input unit satisfies the FDA validation requirements of 21 CFR PART 11.

Preferably, the input unit IU is connectable with a communications network CN.

The invention will now be explained in greater detail on the basis of an example of an embodiment in the drawings, whose figures show as follows:

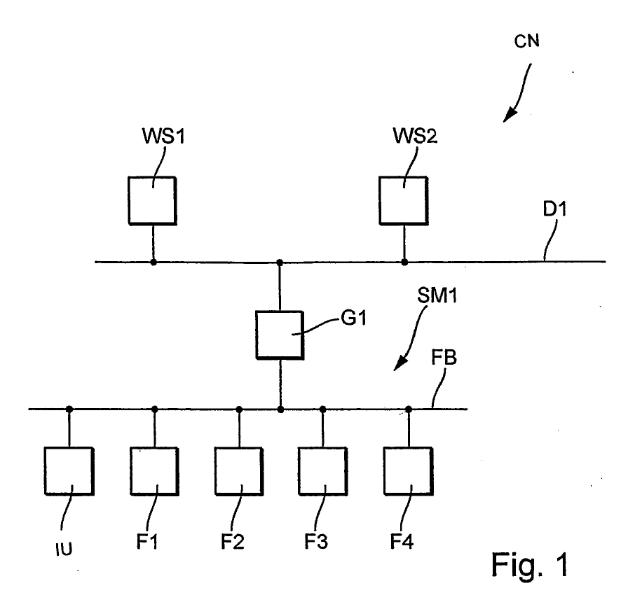

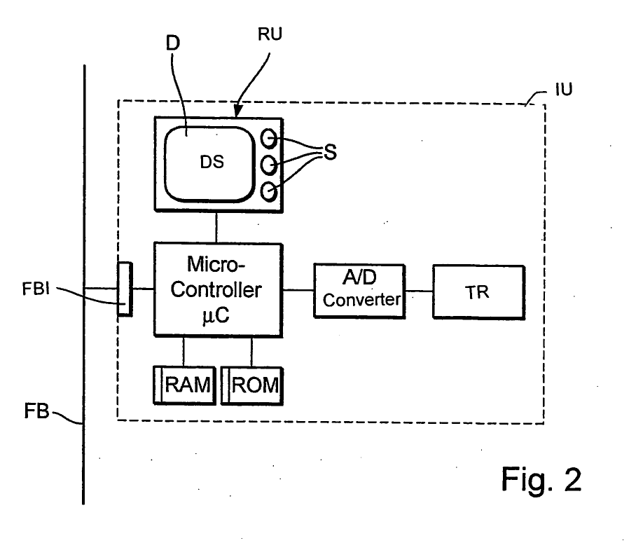

FIG. 1 schematic illustration of a process control system

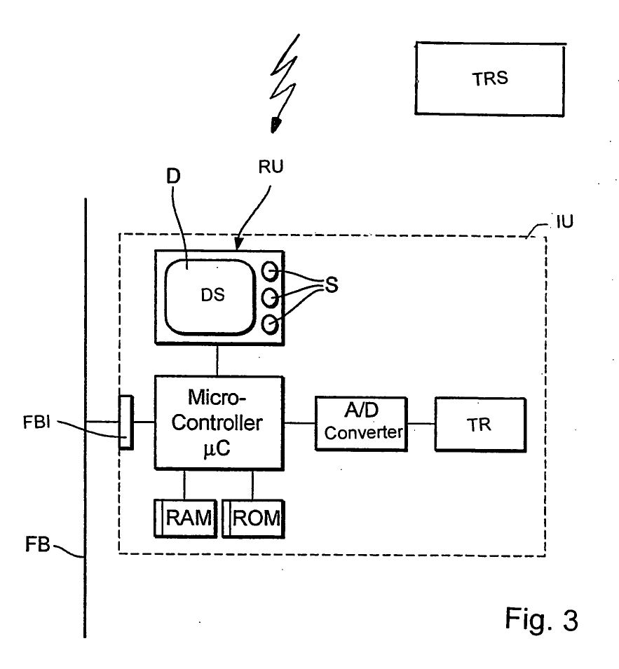

FIG. 2 schematic illustration of an input unit of the invention for a field device

FIG. 1 illustrates in greater detail a process control system for a field device, wherein the system serves as a communications network CN. Multiple control systems, respectively control units (workstations) WS1, WS2, serving for process visualization, process monitoring, and engineering, are connected to a data bus D1. The data bus D1 operates e.g. according to the HSE (high speed Ethernet) standard of Foundation® Fieldbus. The data bus D1 is connected via a gateway G1, also referred to as a “linking device,” with a field bus segment SM1. The field bus segment SM1 is composed of multiple field devices F1, F2, F3, F4, and an input unit IU, which are connected with one another by way of a field bus FB. The field bus operates e.g. according to the Foundation Fieldbus standard. However, the invention is not limited to this specific field bus system.

FIG. 2 illustrates in greater detail the input unit IU for the field device. The input unit IU can be e.g. an integral part of the field device. By way of example, a sensor is illustrated. The input unit IU includes a microcontroller μC, which, via an analog-digital converter A/D, is connected with transducer TR, serving to register a process variable (e.g. temperature, pressure, flow rate). A display/service unit DS which is also connected with the microcontroller μC, serves for servicing the field device and displaying various information. The usual RAM and EPROM serve as memory for programs and parameters. The microcontroller μC is connected with the field bus FB via a field bus interface FBI. By means of the field bus FB, e.g. data can be exchanged between the field devices and the superordinate units WS1, respectively WS2. The display/service unit DS has a display D and multiple switches S. The display D is implemented as a so-called LCD touch screen, and serves as the registering unit RU for the electronic signature.

The functioning of the apparatus of the invention will now be described in greater detail.

A user can identify oneself on site at the input unit IU by means of one's own handwritten signature. Here, one writes one's name (signature) on the display D with an appropriate pen. This makes the signature of the user available in electronic form. Electronic documents e.g. calibration records, inspection reports, or data recorded by a recording device, can be shown on the display D, such that they can be signed on site by the user. The electronic signature can thus be saved together with the corresponding documents. Additionally, the user can annotate the documents shown, in that the user can e.g. enter handwritten notes or mark-up selected areas e.g. using arrows or circles. If necessary, these entries can be saved such that they are unchangeable, and/or be provided with the clock-time of the entry. Similarly, the entries can be saved such that they can no longer be erased after the fact.

In addition to the signing of documents, the signature of the user can also serve for the access control of the field devices. In this case, the signature in the field device F1 is compared with stored signatures. In an alternative embodiment of the invention, the signature is transferred via an additional communications connection (e.g. radio transmission (Wi-Fi), Ethernet, infrared) to a superordinate control unit, and is there compared with the signatures stored therein. The user can carry out modifications at the field device only when the signature entered matches one of the stored signatures.

In an alternative embodiment of the invention, the user no longer needs to enter one's signature by hand via the display, but, instead, by means of a portable transmitter in which the signature is stored, one transfers one's signature to a corresponding registering unit. In this case, the display D need not be complexly implemented as a touch screen.

For signing documents or for access control, it suffices that the user, with the portable transmitter, approaches the input unit IU, and the user's electronic signature is transferred to the input unit IU. Especially suited for such a transmitter are so-called “Smartlabels” or “Radiotags,” which are also referred to as electronic labels. These labels involve transponders, which are queried from a distance of circa 2 m using a radio signal, and which decode this signal accordingly. From this signal, the power needed for signal processing is obtained. The label issues its answering report also as a radio signal.

With the input unit IU of the invention, a secure and definite identification of a user, which also satisfies strict validation requirements, is possible.

1-11. (canceled)

12. An input unit for a field device, comprising:
a registering unit serving as an electronic identifier of a user, which enables a definite identification of the user; and
means for connecting said registering unit to the field device.

13. The input unit as claimed in claim 12, wherein:
said electronic identifier is a signature.

14. The input unit as claimed in claim 13, wherein:
said registering visit has a display; and
the signature is entered by the user by hand via said display.

15. The input unit as claimed in claim 13, further comprising:
a portable transmitter, wherein:
the signature is transferred from said portable transmitter via radio transmission to said registering unit.

16. The input unit as claimed in claim 12, wherein:
the signature serves for the signing of electronic documents.

17. The input unit as claimed in claim 12, wherein:
the input unit is implemented as a field device.

18. A transmitting unit for process automation technology, to an input unit having a registering unit, comprising:
means for storing an electronic signature of the user therein, and wirelessly transmitting the signature to said registering unit.

19. An input unit as claimed in claim 12, wherein:
it satisfies the FDA certification regulations 21 CFR Part 11 Rules.

20. The input unit as claimed in claim 12, wherein:
the input unit is connectable to a communications network.

21. The input unit as claimed in claim 14, wherein:
electronic documents shown on said display can, using inputs via the display, be signed, and/or annotated, in handwriting by the user.

22. The input unit as claimed in claim 14, wherein:
annotations to the electronic documents are saved such that they are unchangeable, and/or provided with the clock-time of the input.
